(19) United States
(12) Patent Application Publication
(10) Pub. No.: US 2026/0226930 A1
(43) Pub. Date: Aug. 6, 2026

(54) Clip

(71) Applicant: Illinois Tool Works Inc., Glenview, IL (US)

(72) Inventor: Adriaan Broodryk, Clichy (FR)

(21) Appl. No.: 19/530,575

(22) Filed: Feb. 5, 2026

(30) Foreign Application Priority Data
Feb. 6, 2025 (EP) 25315039.5
Jan. 20, 2026 (DE) 10 2026 102 360.6

(51) Int. Cl. F16B 5/06; F16B 2/20

(52) U.S. Cl. CPC F16B 5/0621; F16B 2/20

(57) ABSTRACT

A clip for securing a substrate to a support is disclosed. The substrate includes a hole, and the support carries a stud. The clip includes a top side, a bottom side, and a main body formed by a plurality of separated sectors. Each sector includes a gripping arm that collectively define a cylindrical conduit configured to retain the stud when the stud is inserted from the bottom side of the clip. The sectors are separated by radial spacings and are interconnected by resilient portions. The radial spacings and resilient portions resiliently bind the sectors together and permit elastic deformation of the gripping arms such that, when the cylindrical conduit is inserted into the hole from the top side of the substrate, the gripping arms engage and secure the clip to the substrate.

### RELATED APPLICATIONS

The present application claims the benefit of European Patent Application No. EP 25315039.5, filed Feb. 6, 2025, and German Patent Application No. DE 10 2026 102 360.6, filed Jan. 20, 2026, each titled “Clip,” the contents of which are hereby incorporated by reference.

### TECHNICAL FIELD

The application relates to a clip for securing together a substrate having a hole to a support supporting a stud. The clip may be suitable for attaching a substrate to a support having a stud, the support being a part of a vehicle, for example an underside of a vehicle.

### BACKGROUND

Improved drivetrains in vehicles have resulted in a decrease in sound production. In order to provide audible feedback at low speed, when pedestrians may be nearby, vehicles must be fitted with a sound box, arranged to emit an audible sound external to the vehicle below a set speed. These need to be attached to a vehicle in such a way as to minimize sound conduction to the interior of the vehicle. Previous attempts use an elastomer bushing which can be difficult to fit and/or be damaged in the fitting process. Such methods are also time-consuming and difficult, requiring multiple parts for an operative to interact with.

### SUMMARY

The present disclosure relates generally to a clip, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein. To easily identify the discussion of any particular element or act, the most significant digit or digits in a reference number refer to the figure number in which that element is first introduced.

FIG. 1 and FIG. 2 illustrate the clip before and after being assembled through a substrate, in a perspective view.

FIG. 3 and FIG. 4 illustrate the clip assembled through the substrate of FIG. 1 and FIG. 2, before and after further assembly of a stud, in a perspective view.

FIG. 5 illustrates the clip alone, in a perspective view.

FIG. 6 illustrates the clip alone, in a top view.

FIG. 7 illustrates the clip alone, in a side view.

FIG. 8 illustrate the clip of FIG. 7 in another side view and assembled through the substrate and after further assembly of a stud as in FIG. 4.

The term “stud” is used to indistinctly designate any releasably fixing element having an external thread, or a part of it, like a screw, a part of a screw, a threaded fastener.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The words ‘inner’, ‘inwardly’, ‘outer’ and ‘outwardly’ refer to directions toward and away from, respectively, a designated centerline or a geometric center of an element being described (e.g. central axis), the particular meaning being readily apparent from the context of the description. Further, as used herein, the terms ‘connected’, attached’, coupled’ and ‘mounted’ are intended to include direct connections between two members without any other members interposed therebetween, as well as indirect connections between members in which one or more other members are interposed therebetween. The terminology includes the words specifically mentioned above, derivatives thereof, and words of similar importance. Further, unless otherwise specified, the use of ordinal adjectives, such as, “first”, “second” and “third” etc.

According to the disclosure there is provided a clip for securing together a substrate having a hole to a support supporting a stud, the clip having a top side, a bottom side, and a main body comprising separated sectors having gripping arms forming a cylindrical conduct configured to retain the stud when said stud is inserted in said cylindrical conduct from the bottom side, said sectors being separated from each other by radial spacings and joining together by resilient portions, said radial spacings and resilient portions resiliently binding said sectors and allowing the gripping arms to grip onto the substrate when the cylindrical conduct is inserted into the hole from the top side. The clip is provided in a single piece thereby speeding up fitment. The resilient portions provide a damping effect thereby limiting acoustic conduction across the clip and also being agnostic to stud size.

Preferably, there are three sectors separated from each other by three radial spacings, and optionally wherein said radial spacings extend radially from the cylindrical conduct. Each sector may be provided with one of the gripping arms, to share grasping of a stud between the radial spacings.

Suitably, the resilient portions allow the cylindrical conduct to expand outward or to narrow inward, to achieve a successful connection.

Appositely, the interior surface of the cylindrical conduct comprises a discontinuous teeth or thread, wherein said discontinuous teeth or thread are optionally divided in a complementary manner on each of the gripping arms. Such discontinuous teeth or thread may be sized to be complimentary with a corresponding feature on a stud. Where a thread is used, dismount of the clip may be achieved by rotating the clip relative to the stud and thereby unscrewing the thread from the stud.

Preferably, the gripping arms comprise retaining elements protruding radially from an exterior surface of the gripping arms opposite to an interior surface of said gripping arms in the cylindrical conduct. The retaining elements are optionally configured to retain (such as but not limited to, by abutment) any removing of the gripping arms from the hole when the cylindrical conduct is inserted into the hole from the top side. This provides an improved security of fitment.

Suitably, hollows are provided in the main body and/or flat surfaces on the exterior surface of the gripping arms.

Appositely, the clip may further comprise a damping nut, which absorbs and prevents the passage of sound across the clip.

Suitably, a bottom damping member is provided on the bottom side of the main body and/or a top damping member on the top side of the main body.

Preferably, the bottom damping member and/or the top damping member are arranged around the cylindrical conduct.

Appositely, the top damping member and/or said bottom damping member have resilient portions optionally above and/or under the resilient portions of the main body.

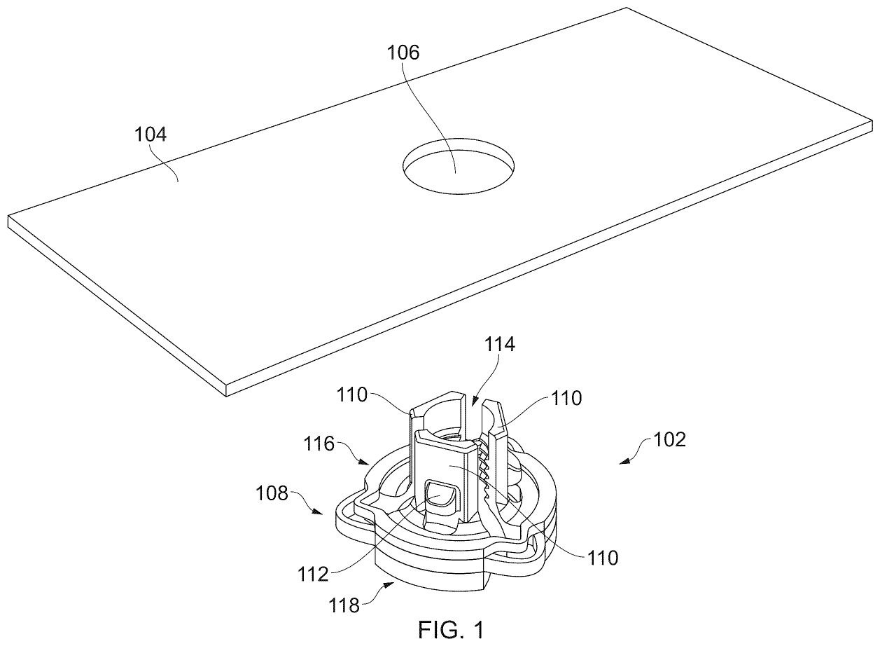

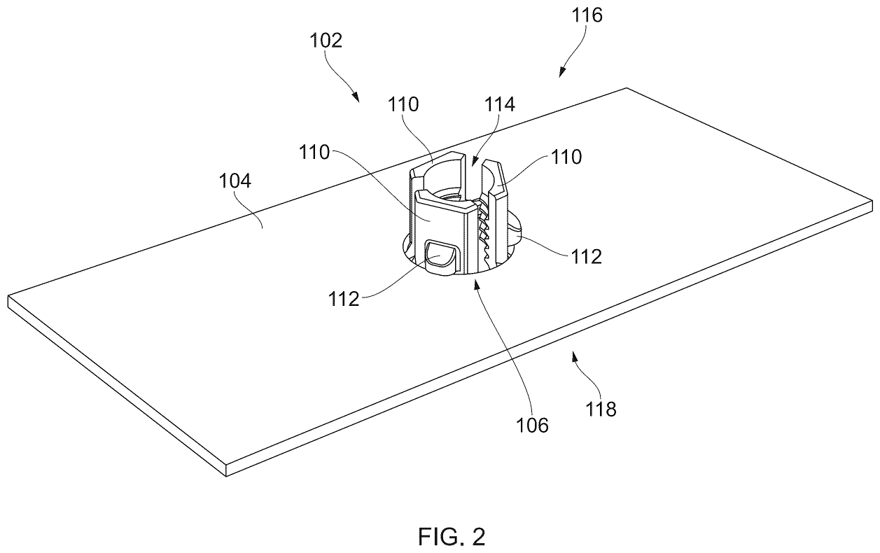

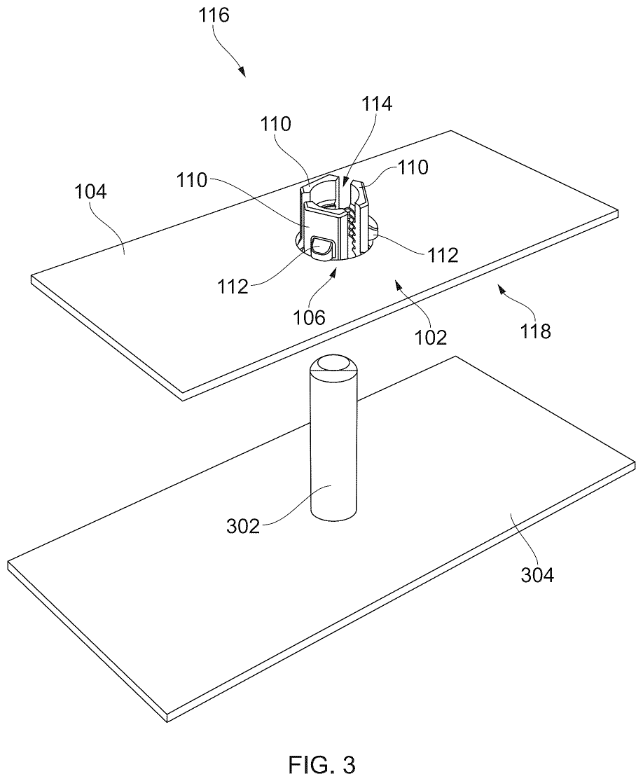

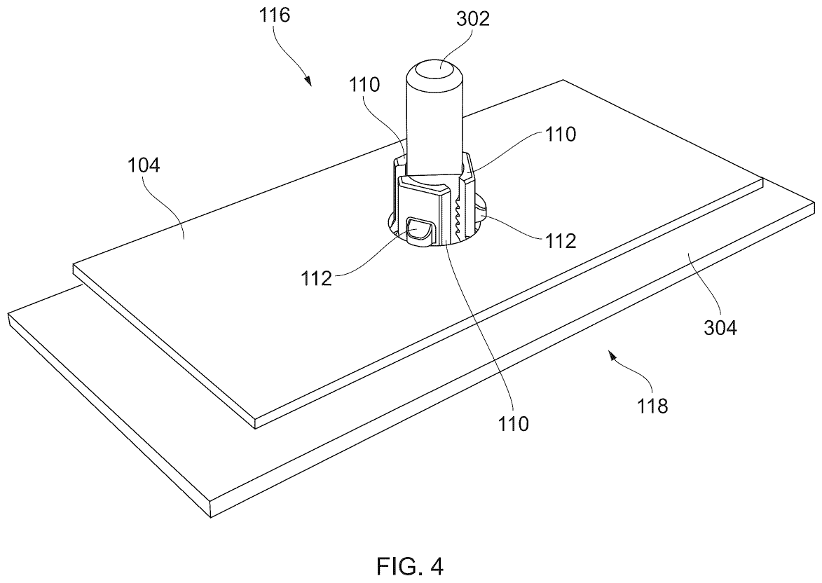

FIG. 1, FIG. 2, FIG. 3 and FIG. 4 illustrate a clip 102 of the disclosure and its assembly process with a hole 106 in a substrate 104 and with a stud 302.

The stud 302 is for example of the type of a standard M6 screw.

The clip 102 is for securing together said substrate 104 having a hole 106 to said support 304 supporting the stud 302.

The clip 102 also aims to reduce vibration of said substrate 104 regarding said support 304.

The substrate 104 and/or the support 304 are for example parts of a vehicle (not illustrated), especially for example an underside of a vehicle.

The clip 102 has a top side 116, a bottom side 118 opposed to said top side 116, and a main body 108 in between.

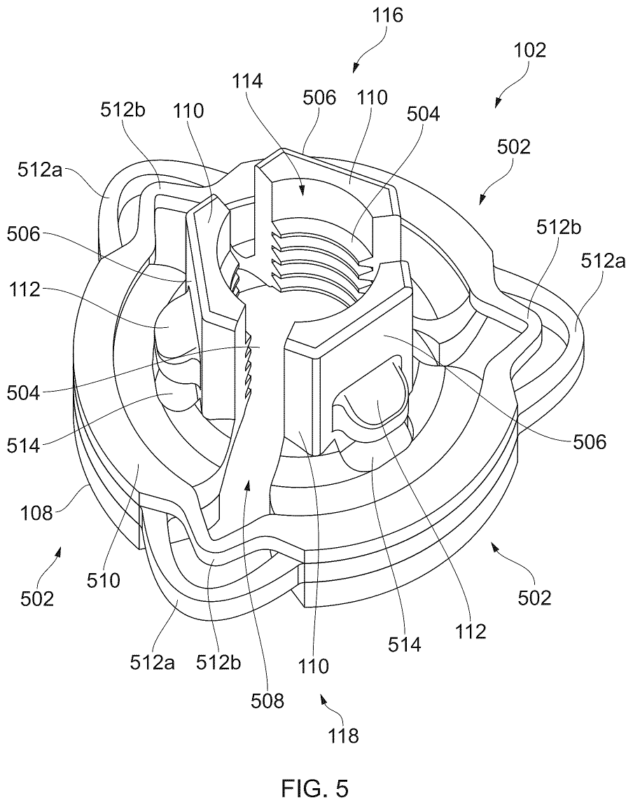

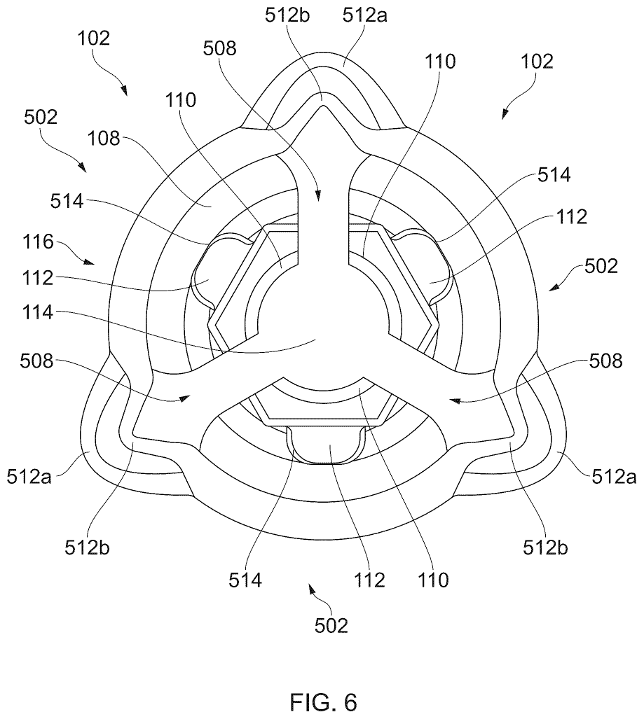

As illustrated in FIG. 5 and FIG. 6, the main body 108 comprises separate sectors 502.

The sectors 502 are separated from each other by radial spacings 508.

As illustrated in FIG. 6, the sectors 502 can form together a hexagonal shape configured to allow to unscrew the clip 102 and the substrate 104 from the threaded stud 302 after assembly, by turning said hexagonal shape with a simple and/or standard tool, like a socket.

Any other suitable form may be provided with the sectors 502 to facilitate the screwing and/or unscrewing of the clip 102 regarding the substrate 104 with a specific or standard tool.

In examples, there are three sectors 502 in the clip 102.

In examples, the three sectors 502 are separated from each other by three radial spacings 508.

The sectors 502 are joined together by resilient portions 512a.

In examples, the main body 108 has three resilient portions 512a.

The radial spacings 508 and resilient portions 512a resiliently bind said sectors 502.

The sectors 502 have gripping arms 110.

As they aim to grip the stud 302 which is a hard element, usually metallic, the gripping arms 110 can comprise a hard compound, as a semi-crystalline thermoplastic like polyoxymethylene.

In examples, each sector 502 has one of the gripping arms 110.

The gripping arms 110 form together a cylindrical conduct 114.

The cylindrical conduct 114 is configured to fit in the hole 106.

In examples, the radial spacings 508 extend radially from the cylindrical conduct 114.

The radial spacings 508 allow the cylindrical conduct 114 to expand outward or to narrow inward.

The cylindrical conduct 114 is configured to retain the stud 302 when said stud 302 is inserted in said cylindrical conduct 114 from the bottom side 118.

The cylindrical conduct 114 is also configured to block the stud 302 therein when said stud 302 is forced out of said cylindrical conduct 114 through the bottom side 118.

Indeed, when the whole cylindrical conduct 114 expands with the gripping arms 110 expanding together, the sectors 502 move apart simultaneously, while they move closer simultaneously when the cylindrical conduct 114 narrows, which allows the insertion of the stud 302, and the increased retaining of the cylindrical conduct 114 in the hole 106.

Moreover, the resilient portions 512a allow the cylindrical conduct 114 to resiliently get back to a rest position by working against the inward or outward expansion/opening or narrowing/closing of the cylindrical conduct 114.

The radial spacings 508, which can retract or expand with the work of the resilient portions 512a, allow that the cylindrical conduct 114 can either retract to enter in the hole 106 or expand in a blocking manner when inserted therein.

Then, the radial spacings 508 and resilient portions 512a allow the gripping arms 110 to grip onto the substrate 104 when the cylindrical conduct 114 is inserted into the hole 106 from the top side 116.

In other terms, the radial spacings 508 and the resilient portions 512a working together can have the cylindrical conduct 114 snapping onto the substrate 104 when inserted through the hole 106, which is a particularly easy and quick way of fixing the clip 102 onto the substrate 104 for an operator, without requiring any tool.

The interior surface of the cylindrical conduct 114 can comprise a discontinuous teeth or thread 504.

The discontinuous teeth or thread 504 is divided in a complementary manner on each of the three gripping arm 110.

The discontinuous teeth or thread 504 allows a strong gripping of the stud 302 by screwing, as said stud 302 comprises an external thread.

Alternatively, the stud 302 is secured together with the clip 102 by friction of said stud 302 into the cylindrical conduct 114, which allows a quick assembly by snapping of said stud into the cylindrical conduct 114.

Thus, the clip 102 can be quickly secured with the support 304 supporting the stud 302, with or without screwing.

The gripping arms 110 can comprise retaining elements 112.

The retaining elements 112 are configured to increase the maintaining of the clip 102 onto the substrate 104.

In examples, the retaining elements 112 are protruding radially from an exterior surface of the gripping arms 110 opposite to an interior surface of said gripping arms 110 in the cylindrical conduct 114.

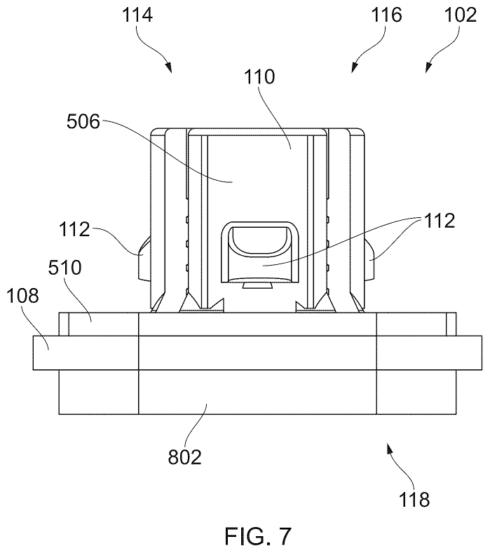

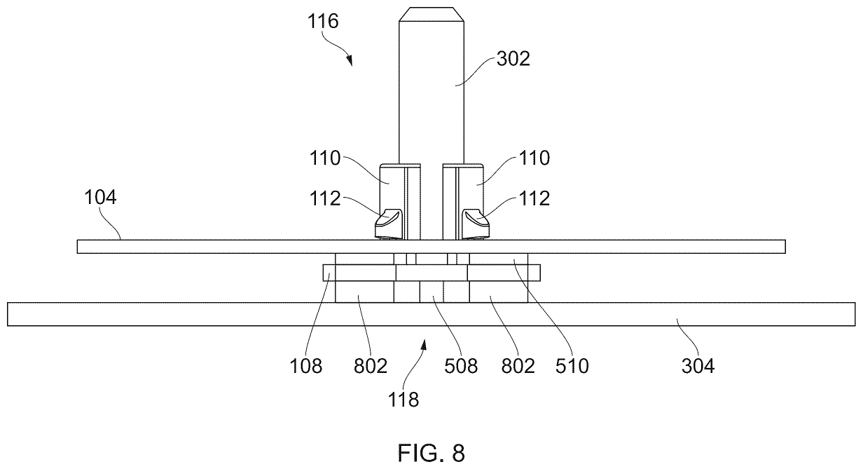

As illustrated in FIG. 7 and FIG. 8, the retaining elements 112 can be configured to retain, for example by abutment, any reverse removing of the gripping arms 110 from the hole 106 when the cylindrical conduct 114 is inserted into the hole 106 from the top side 116.

The clip 102 can further comprise hollows 514 in the main body 108.

The hollows 514 diminish material of the main body 108 and make it lighter.

The clip 102 can further comprise flat surfaces 506 on the exterior surface of the gripping arms 110.

The clip 102 can further comprise a damping nut.

The clip 102 as a damping nut can further be provided with a bottom damping member 802 and/or a top damping member 510.

The bottom damping member 802 is on the bottom side 118 of the main body 108, for example over molded thereon.

The bottom damping member 802 can be formed with several parts, for example three parts, each provided on a bottom side 118 of one of the three sectors 502.

The top damping member 510 is on the top side 116 of the main body 108, for example over molded thereon.

The top damping member 510 can further lie around the cylindrical conduct 114.

The top damping member 510 can have resilient portions 512b, allowing said top damping member 510 to follow the movements of expansion or narrowing of the main body 108 without breaking or be damaged.

The resilient portions 512b of the top damping member 510 can align and/or correspond radially with the resilient portions 512a of the main body 108.

The resilient portions 512b of the top damping member 510 can then be provided above the resilient portions 512a of the main body 108.

The top damping member 510 allows to absorb vibrations from the substrate 104, so that vibrations transmitted from said substrate 104 to the main body 108 are lessened.

The bottom damping member 802 allows to absorb vibrations from the support 304, so that vibrations between the substrate 104 and the main body 108 are lessened.

The top damping member 510 and the bottom damping member 812 can be integral with each other (e.g., integrally over molded on the main body 108). One or more connecting portions can connect the top damping member 510 and the bottom damping member 812 together, for example through the main body 108.

The damping elements can comprise a soft compound, like a polyester plastic, for example polyethylene terephthalate, for a better vibration absorption.

This damping configuration forms a damping nut allowing to lessen vibrations of both of the substrate 104 and of the support 304, which improves both mechanical reliability and acoustic comfort.

The disclosure allows to form a quick assembly or preassembly of a support 304 having a stud 302 with a substrate 104 having a hole 106, the discontinuous teeth or thread 504 allowing to grip the stud 302 by the thread of said stud 302, and the resilience of the structure having lower flexible area at the bottom of the gripping arms 110 to allow the cylindrical conduct 114 to open easily when pushed onto the stud 302 but won't open if pulled in the opposite direction, and to get back in position to have discontinuous teeth or thread 504 clamp and hold said stud 302.

While the present method and/or system have been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A clip (102) for securing a substrate (104) having a hole (106) to a support (304) supporting a stud (302), the clip (102) comprising:
a top side (116);
a bottom side (118); and
a main body (108) comprising a plurality of separated sectors (502), each sector including a gripping arm (110), the gripping arms (110) collectively forming a cylindrical conduit (114) configured to retain the stud (302) when the stud (302) is inserted into the cylindrical conduit (114) from the bottom side (118),
wherein the sectors (502) are separated from one another by radial spacings (508) and are joined to one another by resilient portions (512a), and
wherein the radial spacings (508) and the resilient portions (512a) resiliently bind the sectors (502) and permit the gripping arms (110) to engage the substrate (104) when the cylindrical conduit (114) is inserted into the hole (106) from the top side (116).

2. The clip (102) of claim 1, wherein the main body (108) comprises three sectors (502) separated from one another by three radial spacings (508).

3. The clip (102) of claim 2, wherein each radial spacing (508) extends radially outward from the cylindrical conduit (114).

4. The clip (102) of claim 1, wherein each sector (502) includes a single gripping arm (110).

5. The clip (102) of claim 1, wherein the resilient portions (512a) permit the cylindrical conduit (114) to elastically expand radially outward and contract radially inward.

6. The clip (102) of claim 1, wherein an interior surface of the cylindrical conduit (114) includes a discontinuous tooth or thread structure (504).

7. The clip (102) of claim 6, wherein the discontinuous tooth or thread structure (504) is divided among the gripping arms (110).

8. The clip (102) of claim 1, wherein each gripping arm (110) includes a retaining element (112) protruding radially outward from an exterior surface of the gripping arm (110), the retaining element (112) being configured to resist removal of the clip (102) from the hole (106).

9. The clip (102) of claim 1, wherein the main body (108) includes one or more hollows (514) and/or flat surfaces (506) formed on an exterior surface of the gripping arms (110).

10. The clip (102) of claim 1, further comprising at least one damping element associated with the main body (108).

11. A fastening assembly comprising:
a support (304) including a stud (302);
a substrate (104) defining a hole (106); and
a clip (102) inserted through the hole (106) to secure the substrate (104) to the support (304),
wherein the clip (102) includes a deformable cylindrical conduit (114) configured to receive and retain the stud (302), and
wherein the clip (102) includes a plurality of resiliently interconnected sectors (502) that expand during insertion into the hole (106) and contract to grip the substrate (104).

12. The fastening assembly of claim 11, wherein the sectors (502) are separated by radial spacings (508) extending along a longitudinal axis of the clip (102).

13. The fastening assembly of claim 11, wherein each sector (502) includes a gripping arm (110) defining a portion of the cylindrical conduit (114).

14. The fastening assembly of claim 11, wherein resilient portions (512a) interconnect adjacent sectors (502) and bias the sectors toward a relaxed position.

15. The fastening assembly of claim 11, wherein the cylindrical conduit (114) includes an internal discontinuous thread or tooth structure (504) configured to engage the stud (302).

16. The fastening assembly of claim 11, wherein the clip (102) includes a top damping member (510) positioned on the top side (116) of the main body (108).

17. The fastening assembly of claim 11, wherein the clip (102) includes a bottom damping member (802) positioned on the bottom side (118) of the main body (108).

18. The fastening assembly of claim 17, wherein the bottom damping member (802) surrounds the cylindrical conduit (114).

19. The fastening assembly of claim 16, wherein the top damping member (510) includes resilient portions (512b) axially offset from the resilient portions (512a) of the main body (108).

20. The fastening assembly of claim 11, wherein the clip (102) further comprises a damping nut configured to reduce vibration between the stud (302) and the clip (102).
